(19) United States
(12) Patent Application Publication
(10) Pub. No.: US 2009/0096688 A1
(43) Pub. Date: Apr. 16, 2009

(54) Antenna system and an in-vehicle communication apparatus

(75) Inventors: Kiyokazu Akiyama, Okazaki-city (JP); Yuzi Sugimoto, Kariya-city (JP); Taizo Mizutani, Nagoya-city (JP); Michio Shamoto, Konan-city (JP)

Correspondence Address: HARNESS, DICKEY & PIERCE, P.L.C., P.O. BOX 828, BLOOMFIELD HILLS, MI, 48303, US

(73) Assignees: Nippon Soken, Inc., Nishio-city (JP); DENSO CORPORATION, Kariya-city (JP)

(21) Appl. No.: 12/287,755

(22) Filed: Oct. 13, 2008

(30) Foreign Application Priority Data
Oct. 16, 2007 (JP) 2007-268754

(51) Int. Cl. H01Q 19/10; H01Q 1/32

(52) U.S. Cl. 343/711; 343/834

(57) ABSTRACT

An antenna system for use in a wide frequency band has a reflection board that has a board shape with an outer edge and an inner edge. The antenna system connects the reflection board and an antenna module in a manner that does not allow a flow of a direct current. Further, a dimension of the reflection board along a polarization direction of the antenna module has a value that is equal to or greater than a product of a maximum wavelength of a usable frequency band multiplied by a wavelength reduction rate of a dielectric material.

### CROSS REFERENCE TO RELATED APPLICATION

The present application is based on and claims the benefit of priority of Japanese Patent Application No. 2007-268754 filed on Oct. 16, 2007, the disclosure of which is incorporated herein by reference.

### FIELD OF THE INVENTION

The present disclosure generally relates to an antenna system and a communication apparatus for use in a vehicle.

### BACKGROUND INFORMATION

In recent years, an antenna with an improved performance for use in a wide frequency band is proposed. For example, an antenna for use in a high speed communication such as Ultra Wide Band (UWB) communication is devised as a bi-conical antenna that combines a conic and a sphere element, or as a mono-cone antenna.

Further, a printed-circuit board antenna that is easily formed by forming a pattern on a printed circuit board is also used for a wide frequency band communication as, for example, disclosed in Japanese patent document JP-A-2006-345038 beside the antenna having a three-dimensional shape described above.

The antenna system for use in a wide frequency band has not been used in a situation that assumes directivity of the antenna. However, the directivity of the antenna may possibly be required in recent years. For example, when the wide frequency band antenna is used for an in-vehicle communication apparatus, the antenna preferably transmits the radio wave only toward the vehicle compartment, and not toward an outside of the vehicle for preventing the jamming with the vehicle in the surroundings and for preventing information leakage.

The directivity of the wide frequency band antenna may be realized by the use of a reflection board. The reflection board is usually disposed at a distance of quarter wavelength from the antenna. However, the wide frequency band antenna may be used in a wide range of frequency, and the required distance of the reflection board from the antenna may be changed according to the frequency. For example, when the frequency of the radio wave in a lower band of UWB varies in a range of 3.1 to 4.8 GHz, the wavelength changes from 96.8 mm to 62.5 mm. Therefore, a fixed distance derived from the wavelength of a certain frequency in the band may not bring a maximum performance of the antenna.

### SUMMARY OF THE INVENTION

In view of the above and other problems, the present disclosure provides an antenna system having a reflection board that suitably realizes a directivity of the antenna for a wide range of the frequency band in use.

The antenna system, as an aspect of the present invention, has an antenna module for a wide frequency band and a reflector. The reflector is used for realizing a directivity of the antenna module. The reflector is made of a dielectric material having a board shape. The board shape of the reflector has an outer edge and an inner edge.

The reflector in the antenna system generally provides a strong directivity in a direction that extends from the reflector to the antenna module when the reflector is efficiently functioning. This is because a reverse-phase electric current is generated on a surface of the reflector relative to a current in the antenna module when the antenna module transmits or receives the radio wave having a certain wavelength, and thereby strengthening the radio wave from the antenna module in the directivity forming direction and weakening the radio wave in the reverse direction. Further, when the electric current path on the surface of the reflector has the length that is equal to an integral multiple of α times of a quarter of the wavelength of the radio wave, the directivity is strongly formed due to the resonance that facilitates the flow of the electric current. In this case, α is a wavelength reduction rate of the reflector surface in a direction that is in parallel with the surface of the reflector.

Because the reflector of the present invention has the inner edge, the electric current in the reflector generates a path that goes around the inner edge. The electric current path going around the inner edge has a variation that includes a path of the inner edge itself and a path of the outer edge itself. Therefore, the reflector functions efficiently in a wide range of the usable frequency band due to the wide variation of the electric current paths that are allowed to be generated in the reflector.

### BRIEF DESCRIPTION OF THE DRAWINGS

Other objects, features and advantages of the present invention will become more apparent from the following detailed description made with reference to the accompanying drawings, in which:

FIG. 1 is a front view of a substrate and an antenna system in a first embodiment of the present invention;

FIG. 2 is a side view of the substrate and the antenna system;

FIG. 3 is a cross-sectional view along an A-A line in FIG. 1;

FIG. 4 is a front view of an antenna module in the first embodiment of the present invention;

FIG. 5 is a front view of a reflection board;

FIG. 6 is an illustration of a current path in the reflection board;

FIG. 7 is a diagram of a simulation result of the directivity in the horizontal plane of the antenna system in the first embodiment of the present invention;

FIG. 8 is another diagram of a simulation result of the directivity in the horizontal plane of the antenna system in the first embodiment of the present invention;

FIG. 9 is a front view of another shape of the reflection board;

FIG. 10 is a front view of yet another shape of the reflection board;

FIG. 11 is a front view of still yet another shape of the reflection board;

FIG. 12 is a front view of still yet another shape of the reflection board;

FIG. 13 is a front view of still yet another shape of the reflection board;

FIG. 14 is a plan view of an antenna module in a second embodiment of the present invention;

FIG. 15 is a plan view of an antenna module in a third embodiment of the present invention;

FIG. 16 is a diagram of VSWR-frequency characteristics on the antenna module in the first to third and other embodiments of the present invention;

FIG. 17 is an illustration of the antenna element in a modification of one embodiment;

FIG. 18 is an illustration of the antenna element in a modification of one embodiment; and

FIG. 19 is an illustration of the antenna element in a modification of one embodiment.

### DETAILED DESCRIPTION

### First Embodiment

One embodiment of the present invention is explained as follows.

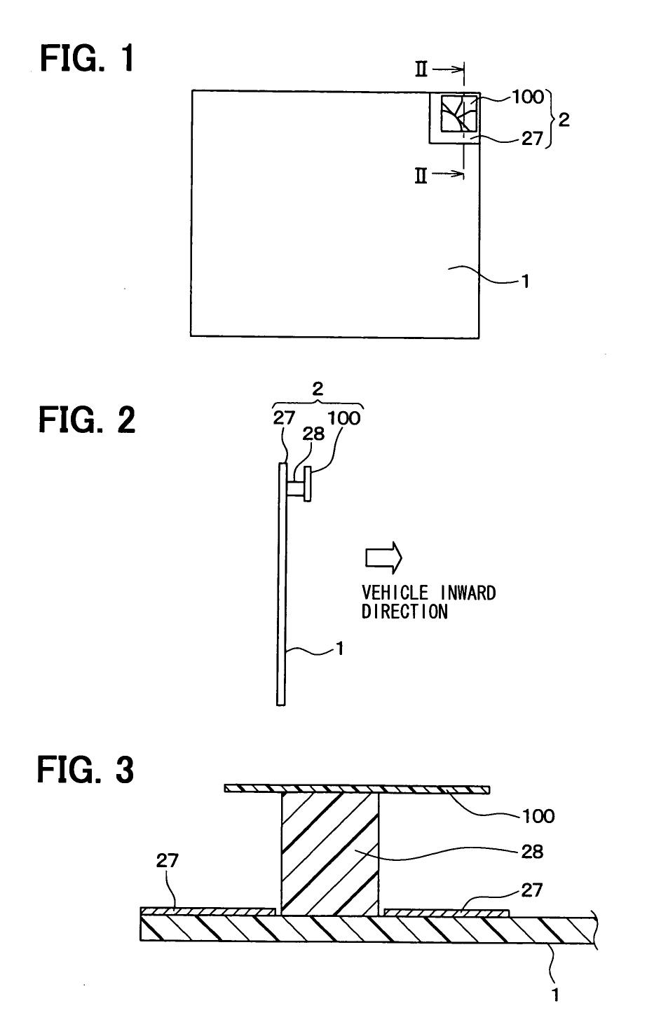

A front elevation and a side view of an antenna system 2 established on a substrate 1 as well as the substrate 1 regarding an embodiment of an in-vehicle radio communication apparatus in an embodiment of the present invention are shown in FIG. 1 and FIG. 2.

The in-vehicle radio communication apparatus is, for example, a vehicle navigation apparatus, and transmits and receives radio waves by using the antenna system 2 for wireless communication with a device such as, for example, a wireless USB memory or the like. The frequency band used for the wireless communication is a broadband. More practically, the frequency band used for the communication is a lower band (3.1-4.8 GHz) of a Ultra Wide Band (UWB).

The in-vehicle radio communication apparatus is disposed in an instrument panel, on a dashboard or the like that is defined as the vicinity of a border between an outside and an inside of a vehicle compartment, and, as shown in FIG. 2, the substrate 1 directs one face toward the inside of the vehicle compartment with the other face directed toward an outside of the vehicle.

The antenna system 2 is disposed on a in-vehicle side surface of substrate 1, and has an antenna module 100, a reflection board 27 and a spacer 28. A cross section of FIG. 1 along a line A-A is shown in FIG. 3.

The reflection board 27 is a pattern of copper foil formed on a compartment side surface of the substrate 1. The shape of the reflection board 27 is described later.

The antenna module 100 is disposed in parallel with the compartment side surface of the substrate 1 in a detached manner from the substrate 1 for facing the surface of the substrate 1. Between the antenna module 100 and the substrate 1, the spacer 28 made of resin is interposed. Each end of the spacer 28 is respectively fixed to the substrate 1 and the antenna module 100. As a result, the antenna module 100 is fixed to the substrate 1 with the spacer 28 interposed therebetween.

(Configuration and Function of Antenna Module 100)

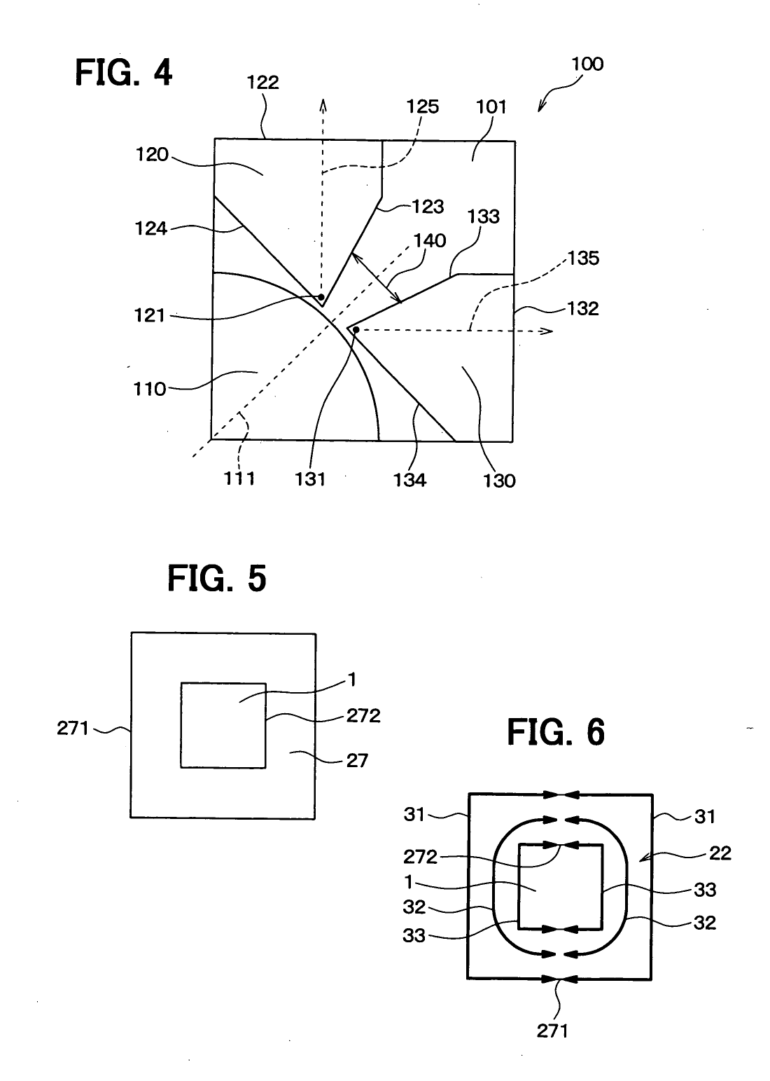

A front elevation of the antenna module 100 is shown in FIG. 4. The antenna module 100 has a dielectric the dielectric substrate 101 which is made from a dielectric, a ground 110 which is a conductor pattern, an the antenna element 120 which is a conductor pattern and an the antenna element 130 which is a conductor pattern as shown in the figure.

The ground 110 is a pattern arranged at a corner of the dielectric substrate 101, and has a 90 degree fan shape that is made by dividing a disc into four equal pieces. Therefore, a circumference of the ground 110 is formed by an arc having a center angle of 90 degrees and two straight lines to connect a center pivot point of the arc and each end of the arc.

The antenna element 120 is a pattern on the dielectric substrate 101 disposed at a proximity of the arc of the ground 110 as shown in an upper left portion of FIG. 4. The antenna element 120 is an antenna element for transmitting and receiving a radio wave that has a polarization surface in parallel with an up-down direction of the drawing (i.e., a vertically polarized wave). The antenna element 120 has a pentagonal shape that resembles a home base of the baseball as is shown in FIG. 4.

In addition, as for the antenna element 120, a feeding point 121 is established in a vertex part that is closest to the ground 110 (in other words, on a ground side end of the antenna element 120) among the vertexes of the pentagonal shape.

Therefore, when an electric current is provided for the feeding point 121 through a coaxial line or a microstrip line from a signal circuit of the in-vehicle radio communication apparatus which is not illustrated, the antenna element 120 transmits and/or receives the vertically polarized wave by having a flow of the current from the feeding point 121 to a farthest side 122 that is farthest relative to the feeding point 121. In this manner, the antenna element 120 functions, as a monopole type antenna element, for the transmission and reception of the electric wave having a wavelength λ₀ equal to or smaller than 4/α of the distance between the feeding point 121 and the side 122.

In other words, the length that is parallel with a surface of polarization of the antenna element 120 and perpendicular to a propagation direction of the radio wave (designated as a polarization direction hereinafter) is α/4 times of the wavelength λ₀ of the lowest frequency of the waveband in use.

In this case, the value α is a wavelength reduction rate that is determined in association with a position, a size, a shape, a dielectric constant of a dielectric in the surroundings such as the dielectric of the dielectric substrate 101, the dielectric of the spacer 28, the dielectric of the substrate 1 and the like). Therefore, the value α changes depending on the position and the direction of the dielectric.

In addition, a distance between a side 123 and a side 124 both extending from the feeding point 121 increases as the measurement position from the feeding point 121 goes farther away from the feeding point 121. Therefore, a portion of the element 120 between the two sides 123, 124 forms a taper portion that has a wider width in proportion to the increase of the distance from the feeding point 121 along the polarization direction, when the with of the portion of the element 120 is measured perpendicular to the polarization direction. The polarization direction may also be designated as a resonance direction.

Further, the element 120 has a constant width to the side 122 from an opposite end of the taper portion relative to the feeding point 121, when the width is measured perpendicular to the polarization direction. In other words, the maximum width of the element 120 measured perpendicularly to the polarization direction is same as the width of the side 122. The maximum width may be simply designated the width hereinafter. As is generally known, the monopole type element has a wider usable frequency band as the width of the element increases. In the example of FIG. 4, the width of the antenna element 120 is α λ₀/4. In this manner, the wider usable band of the element 120 is realized.

The antenna element 130 is a pattern on the dielectric substrate 101 disposed at a proximity of the arc of the ground 110 as shown in a lower right portion of FIG. 4. The antenna element 130 is an antenna element for transmitting and receiving a radio wave that has a polarization surface in parallel with a right-left direction of the drawing (i.e., a horizontally polarized wave). The antenna element 130 has a pentagonal shape that resembles a home base of the baseball as is shown in FIG. 4.

In addition, as for the antenna element 130, a feeding point 131 is established in a vertex part that is closest to the ground 110 (in other words, on a ground side end of the antenna element 130) among the vertexes of the pentagonal shape.

Therefore, when an electric current is provided for the feeding point 131 through a coaxial line or a microstrip line from a signal circuit of the in-vehicle radio communication apparatus, the antenna element 130 transmits and/or receives the horizontally polarized wave by having a flow of the current from the feeding point 131 to a farthest side 132 that is farthest relative to the feeding point 131. In this manner, the antenna element 130 functions, as a monopole type antenna element, for the transmission and reception of the electric wave having a wavelength λ₀ equal to or smaller than 4/α of the distance between the feeding point 131 and the side 132. In other words, the length that is parallel with a surface of polarization of the antenna element 130 and perpendicular to a propagation direction of the electric wave (designated as a polarization direction hereinafter) is α/4 times of the wavelength λ₀ of the lowest frequency of the waveband in use.

In addition, a distance between a side 133 and a side 134 both extending from the feeding point 131 increases as the measurement position from the feeding point 131 goes farther away from the feeding point 131. Therefore, a portion of the element 130 between the two sides 133, 134 forms a taper portion that has a wider width in proportion to the increase of the distance from the feeding point 131 along the polarization direction, when the with of the portion of the element 130 is measured perpendicular to the polarization direction. The polarization direction may also be designated as a resonance direction.

Further, the element 130 has a constant width to the side 132 from an opposite end of the taper portion relative to the feeding point 131, when the width is measured perpendicular to the -polarization direction. In other words, the maximum width of the element 130 measured perpendicularly to the polarization direction is same as the width of the side 132. The maximum width may be simply designated the width hereinafter. In the example of FIG. 4, the width of the antenna element 130 is α λ₀/4. In this manner, the wider usable band of the element 130 is realized.

In addition, the taper portion does not have a line-symmetric shape relative to a straight line 135 that extends in the polarization direction of the antenna element 130 from the feeding point 131. In other words, the area of a part of the element 130 closer to the element 120 relative to the line (a polarization line) 135 is smaller than the area of a part of the element 130 on an opposite side of the polarization line 135.

The polarized wave diversity by the antenna elements 120 and 130 is achieved on the dielectric substrate 101 because the polarization directions of the element 120 and the element 130 are perpendicular with each other. In addition, as for these two antenna elements 120, 130, commonly use the ground 110, the increase of the size of the antenna module 100 having two elements 120, 130 is reduced.

In addition, as the outer periphery of the ground 110 has an arc shape, the gap between the antenna element 120 and the ground 110 increases as the measurement position comes farther away from the antenna element 130 along the periphery. That is, in other words, the ground 110 escapes from the antenna element 120 on the farther side from the element 130. Therefore, resonance of the antenna element 120 in the unnecessary polarization direction is suppressed by the structure described above.

In the same manner, as the outer periphery of the ground 110 has an arc shape, the gap between the antenna element 130 and the ground 110 increases as the measurement position comes farther away from the antenna element 120 along the periphery. That is, in other words, the ground 110 escapes from the antenna element 130 on the farther side from the element 120. Therefore, resonance of the antenna element 130 in the unnecessary polarization direction is suppressed by the structure described above. That is, the arc shaped ground 110 that does not have a corner prevents the resonance in the unnecessary direction.

In addition, the shape of the ground 110 is symmetric relative to an axis 111. Further, the shape of the antenna element 120 and the shape of the antenna element 130 are symmetric relative to the axis 111. Furthermore, the position of the feeding point 121 and the position of feeding point 131 are symmetric relative to the axis 111. By having the above-described structure, the electrical characteristics of the elements 120 and 130 are same relative to the ground 110. Therefore, a factor that deteriorates the performance of one element from the other element among the two elements 120, 130 is removed.

In addition, according to the statement above, by having the taper portion that starts at the vertex with a part having the feeding points 121, 131, the ground 110 can easily have a shape that escapes from the antenna elements 120, 130. Further, by having a wider gap between the two elements 120, 130, an influence between the two elements 120, 130 can be possibly reduced.

More practically, regarding the taper, a gap 140 between the antenna element 130 and the antenna element 120 increases when the distance from the ground 110 increases. By having this structure, the influence between the two elements is further reduced.

When the width of the elements 120, 130 are increased, that contributes to the increase of the serving band, possibly with the deterioration of the diversity performance due to the electrical connection between the elements 120 and 130 caused by the reduction of the gap 140.

Therefore, in the taper part of the antenna element 120, the element 120 has a non-symmetric shape relative to a line 125 that extends along the polarization direction of the element 120 from the feeding point 121. That is, in other words, the area of a part of the element 120 closer to the element 130 relative to the line (a polarization line) 125 is smaller than the area of a part of the element 120 on an opposite side of the polarization line 125.

In addition, in the taper part of the antenna element 130, the element 130 has a non-symmetric shape relative to the line 135 that extends along the polarization direction of the element 130 from the feeding point 131. That is, in other words, the area of a part of the element 130 closer to the element 120 relative to the line 135 is smaller than the area of a part of the element 130 on an opposite side of the polarization line 135.

Therefore, the non-symmetric shape of the antenna elements 120, 130 relative to the axis 111, the width of the element 120 is secured without decreasing the distance between the two elements 120 and 130. Therefore, widening of the usable band of the antenna module 100 can be realized while suppressing deterioration of the performance of the module 100.

(Configuration and Function of Reflection Board)

A front elevation of the reflection board 27 formed on the substrate 1 is shown in FIG. 5. As shown in the figure, the board shape of the reflection board 27 takes a square shape with an outer edge 271 and an inner edge 272. More practically, the reflection board 27 is formed by boring a hole (i.e., a ‘slit’) at a center of a square copper having the outer edge 271 to have the inner edge 272 as described above.

Generally speaking, when a reflector is efficiently functioning, a strong directivity is formed toward a direction that is opposite to an antenna module to reflector direction. This is because a reverse-phase current that is generated on a surface of the reflector relative to a current in the antenna module when the antenna module 100 transmits the radio wave having a wavelength of λ₀. The reverse-phase current strengthen the radio wave in a direction of directivity formation, and cancels the radio wave in a direction that is opposite to the directivity formation direction. Further, when a current path on the surface of the reflector is equal to the integral multiple of α/4 times of the wavelength of the radio wave, the strong directivity is formed by the resonance between the surface current and the radio wave. In this case, the factor α is a wavelength reduction rate along a direction that is in parallel with the surface of the reflector.

The reflection board 27 of the present embodiment is different from a normal reflection board. That is, by having the inner edge 272, a topology of the reflection board is different. Therefore, the current path that circles the inner edge 272 may be generated for bypassing around the hole as shown in FIG. 6. The current path that circles around the inner edge 272 may take several paths such as a path 31 that runs on the outer edge 271 itself, a path 32 that runs on an equidistant position from both of the outer edge 271 and the inner edge 272, a path 33 that runs on the inner edge 272 itself and the like.

Therefore, a wide variation of the length of the current paths can be generated, thereby enabling the reflection board 27 to be efficiently serving for the waveband in a wider range in the present embodiment, that is, the lower band of the UWB. In other words, for transmission and reception of the radio wave at any frequency in the lower band of the UWB, an electric current path having the length of αN/4 times of the wavelength of the corresponding frequency.

In addition, the length of the reflection board 27 in the vertical direction of the drawing in FIG. 5 is at least λ₀α/2. The λ₀ in this case is the upper end o the usable wave band of the antenna module 100. The vertical direction of the drawing is same as the resonance direction 125 of the antenna element 120. In addition, the length of the reflection board 27 in the precisely horizontal direction in the drawing is also at least λ₀ α/2. The precisely horizontal direction in the drawing is same as the resonance direction 135 of the antenna element 130.

In general, the maximum effective length of the reflector along the resonance directions 125, 135 is preferably at least α/2 times of the wavelength of the used radio wave. Therefore, when the reflection board 27 has the length of at least α/2 times of the upper limit wavelength λ₀ of the usable wave band along the resonance directions 125, 135, the reflection board 27 efficiently functions for the entire band of the usable radio wave range.

In addition, the antenna module 100 and the reflection board 27 are not connected in a manner that allows a direct current flowing therebetween. When the connection between the antenna module 100 and the reflection board 27 is not connected in a direct-current allowing manner, the mutual influence for electrically deteriorating the performance is decreased, and, as a result, the performance of the antenna module 100 and the reflection board 27 are improved.

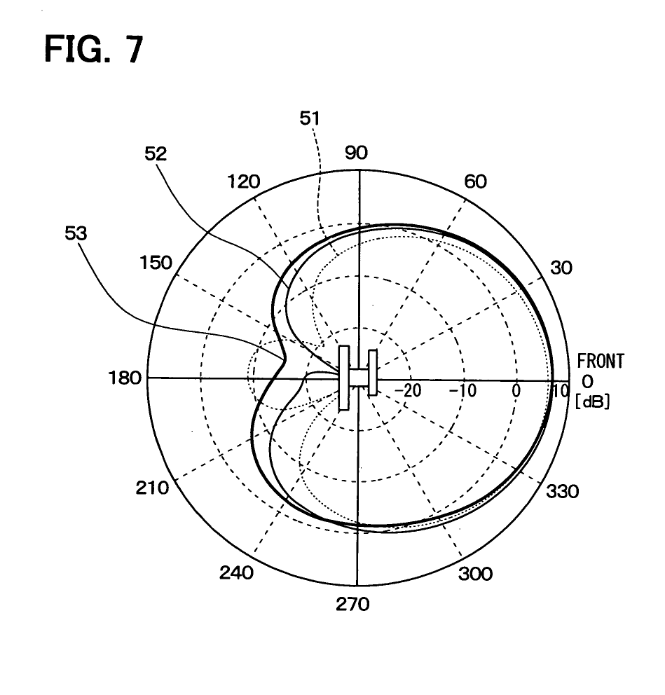

FIG. 7 shows a simulation result of the directivity of the antenna system 2 in a horizontal plane regarding the present embodiment. In this case, the following conditions are assumed. That is, the length of the reflection board:37.6 mm, one side of a square of the inner edge (in other words, one side of the slit):18 mm, the length of the antenna element:15 mm, the radius of the ground:15 mm, a distance between the reflection board and the antenna module:12 mm, a substrate thickness:0.8 mm, a dielectric constant of the board material:4, the shape of the spacer:a quadratic prism that has a square section of 10 mm side in a plane that is in parallel with the substrate, the dielectric constant of the spacer:2.8. The vehicle compartment exists in the right direction of the drawing, and solid lines 51, 52, 53 respectively show the directivity at a frequency of a channel F1 (3,432±264 MHz), a channel F2 (3,960±264 MHz), and a channel F3 (4,488±264 MHz) in the lower band. In this case, the length between the outer edge 271 and the inner edge 271 is λ₀α/6 based on the wavelength λ₀ of 87.4 mm:3432 MHz.

As shown in FIG. 7, the antenna system 2 of the present embodiment can realize a strong directivity toward the front direction in a wide range of the UWB low band, that is, toward the direction of the vehicle compartment. As a result, an information leak to the outside of the vehicle and/or the interference to the adjacent vehicle can be prevented.

As stated above, when the length between the outer edge 271 and the inner edge 272 is increased, the variation of possible current path lengths is widened. According to the simulation by the inventor, the length between a side of the outer edge 271 and a side of the inner edge 272 (i.e., an example of the shortest distance between the outer edge 271 and the inner edge 272) is preferably at least λ₀α/8.

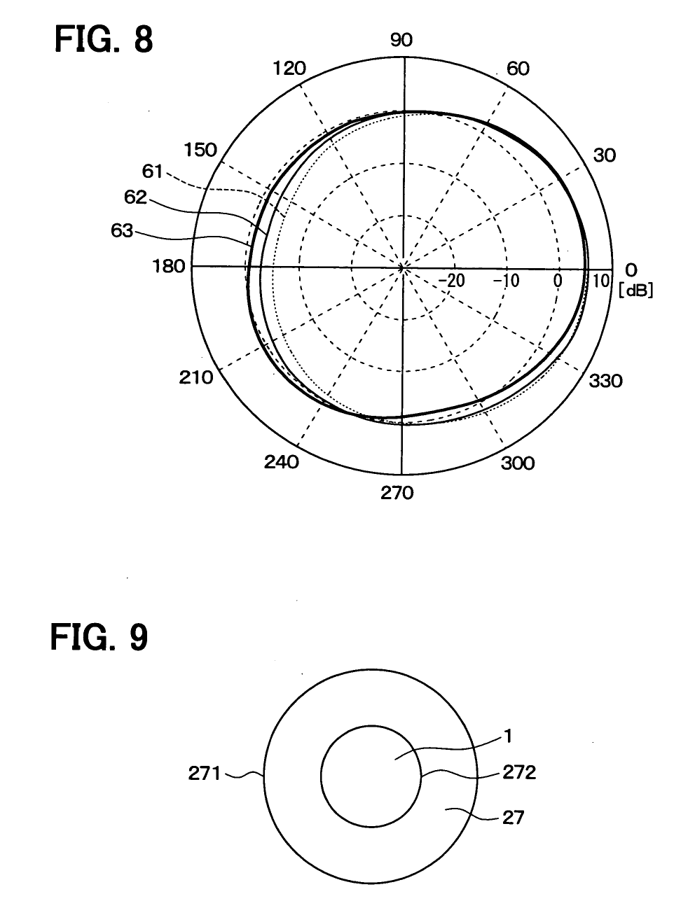

A diagram in FIG. 8 shows a simulation result that, by using a similar simulation condition as FIG. 7, is produced when only the size of the square inner edge is changed to 25 mm. In this case, solid lines 61, 62, 63 respectively show the directivity at the frequency in three channels of F1 (3,432±264 MHz), F2 (3,960±264 MHz), and F3 (4,488±264 MHz) in the lower band.

In this case, the length between the side of the outer edge 271 and the side of the inner edge 272 is λ₀α/10. As shown in the drawing, the function of the reflector starts to deteriorate when the length between the two edges decreases to λ₀α/10.

In addition, when, to the contrary, the size of the inner edge 272 is extremely small (e.g., to 1/100 times of the outer edge), the possible current paths become substantially same as a case that does not have the inner edge 272. That is, the advantageous effects of having the inner edge decrease.

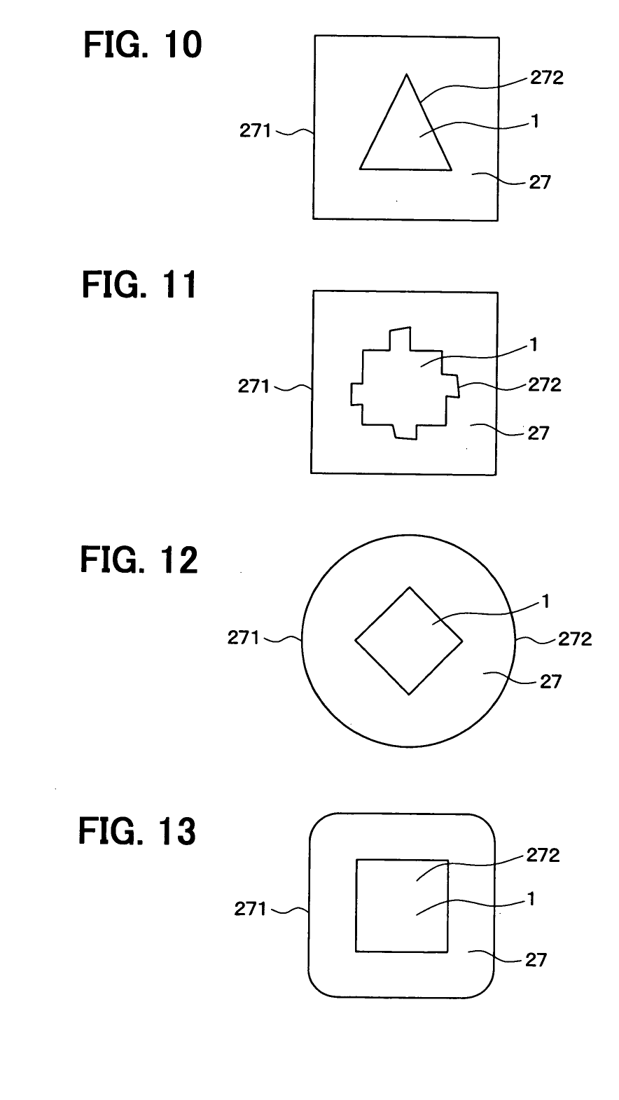

Further, the outer edge 271 and the inner edge of the reflection board 27 of the present embodiment may have a circular shape as shown in FIG. 9. Furthermore, the outer edge 271 may have a square shape and the inner edge may have a triangular shape as shown in FIG. 10. Furthermore, the outer edge 271 may have a square shape and the inner edge 272 may have a complicated shape as shown in FIG. 11. Furthermore, the outer edge 271 may have a circular shape and the inner edge may have a square shape as shown in FIG. 12. Furthermore, the outer edge 271 may have a rounded square shape and the inner edge may have a square shape as shown in FIG. 13.

Furthermore, in the example shown in FIGS. 9 and 12, the reflection board 27 has an improved efficiency when the maximum length of the antenna module 100 along the resonance directions 125, 135 is at least λ₀α/2 (α is the wavelength reduction rate along the resonance directions 125, 135 on the surface of the reflection board 27).

### Second Embodiment

The second embodiment of the present invention is explained in the following.

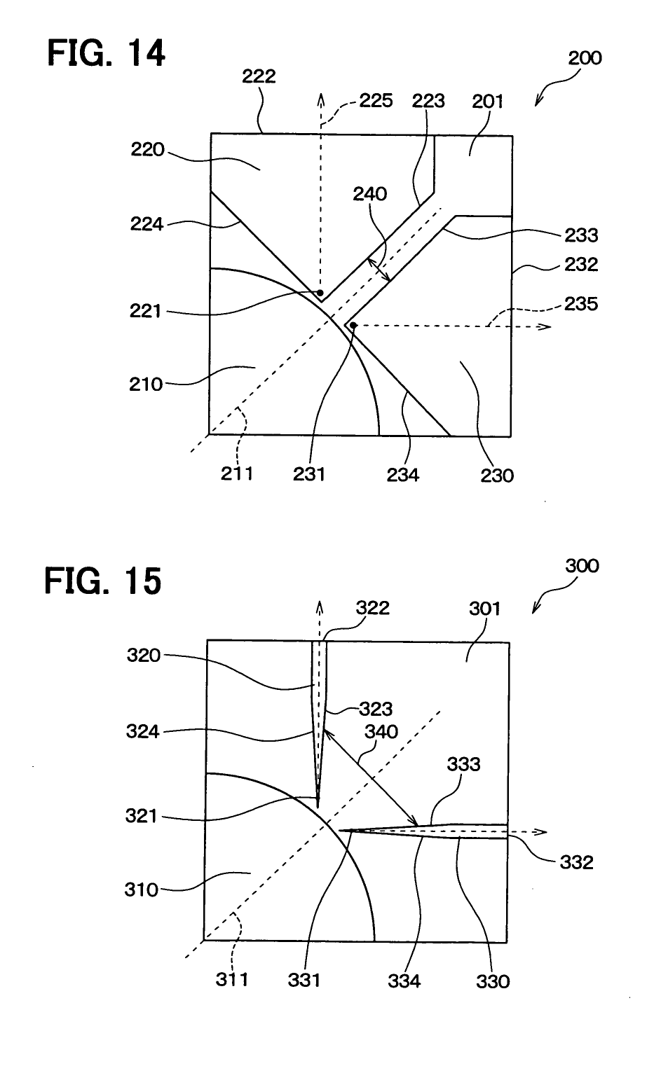

A plan view of an antenna module 200 in the present embodiment is shown in FIG. 14. In the present embodiment, the antenna module 200, a dielectric substrate 201, a dielectric substrate 201, a ground 210, an axis 211, an antenna element 220, a feeding point 221, a side 222 in the taper portion, a side 223 in the taper portion, a side 224 in the taper portion, a polarization line 225, an antenna element 230, a feeding point 231, sides 232, 233, 234 in the taper portion, a polarization line 235, and a gap 240 between the elements respectively correspond to the antenna module 100, the dielectric substrate 101, the ground 110, the axis 111, the antenna element 120, the feeding point 121, the side 122 in the taper portion, the side 123 in the taper portion, the side 124 in the taper portion, the polarization line 125, the antenna element 130, the feeding point 131, the sides 132, 133, 134 in the taper portion, the polarization line 135, and the gap 140 between the elements in the first embodiment.

The antenna module 200 of the present embodiment is different from the antenna module 100 of the first embodiment in two points. The first point is that, in the present embodiment, the width of the sides 222, 232 in the elements 220, 230 is α λ₀/3, compared to the width of the sides 122, 132 in the elements 120, 130 having the value of α λ₀/4. The other point is, while the elements 120, 130 are asymmetrical relative to the polarization lines 125, 135 in the first embodiment, the elements 220, 230 in the present embodiment are symmetric relative to the polarization lines 225, 235.

The antenna module 200 achieves the same advantageous effects of the first embodiment except for a part that is attributed to the asymmetrical shape of the two antenna elements. The degree of usable band widening effect is, however, different from the first embodiment.

### Third Embodiment

The second embodiment of the present invention is explained in the following.

A plan view of an antenna module 300 in the present embodiment is shown in FIG. 15. In the present embodiment, the antenna module 200, a dielectric substrate 301, a dielectric substrate 301, a ground 310, an axis 311, an antenna element 320, a feeding point 321, a side 322 in the taper portion, a side 323 in the taper portion, a side 324 in the taper portion, a polarization line 325, an antenna element 330, a feeding point 331, sides 332, 333, 334 in the taper portion, a polarization line 335, and a gap 340 between the elements respectively correspond to the antenna module 100, the dielectric substrate 101, the ground 110, the axis 111, the antenna element 120, the feeding point 121, the side 122 in the taper portion, the side 123 in the taper portion, the side 124 in the taper portion, the polarization line 125, the antenna element 130, the feeding point 131, the sides 132, 133, 134 in the taper portion, the polarization line 135, and the gap 140 between the elements in the first embodiment.

The antenna module 300 of the present embodiment is different from the antenna module 100 of the first embodiment in two points. The first point is that, in the present embodiment, the width of the sides 322, 332 in the elements 220, 230 is α λ₀/6, compared to the width of the sides 122, 132 in the elements 120, 130 having the value of α λ₀/4. The other point is, while the elements 120, 130 are asymmetrical relative to the polarization lines 125, 135 in the first embodiment, the elements 320, 330 in the present embodiment are symmetric relative to the polarization lines 325, 335.

The antenna module 300 achieves the same advantageous effects of the first embodiment except for a part that is attributed to the asymmetrical shape of the two antenna elements. The degree of usable band widening effect is, however, different from the first embodiment.

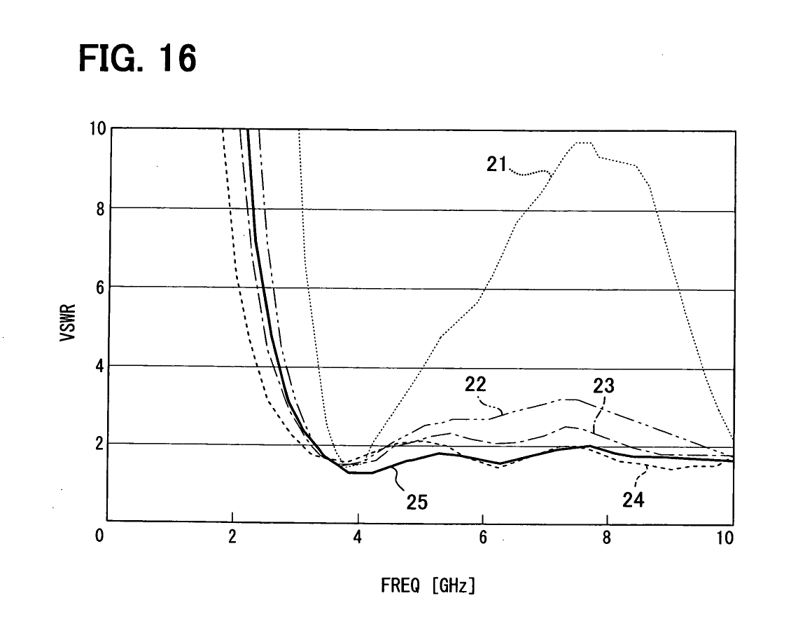

The VSWR—frequency characteristics of the antenna module in the present and other embodiments are shown in FIG. 16 by using a diagram.

A line 21 in the diagram shows a characteristic of the antenna module 300 of the present embodiment, a line 22 shows a characteristic of the antenna module with the width both elements changed to α λ₀/6, a line 23 shows a characteristic of the antenna module with the width both elements changed to α λ₀/4, a line 24 shows a characteristic of the antenna module 200, and a line 25 shows a characteristic of the antenna module 100.

In addition, a vertical axis of the diagram shows a VSWR (voltage standing wave ratio) value, and a horizontal axis shows a frequency by using a unit of GHz. The diagram shows that the performance of the antenna module improves when the VSWR value of a certain frequency decreases.

As shown by the line 25, the antenna module 100 of the first embodiment has the VSWR value equal to or smaller than 2 for almost entire frequency band between 4 GHz to 10 GHz. In addition, as for the antenna module 200 of the second embodiment, the VSWR value becomes equal to or smaller than 2.5 and equal to or greater than 2 for some of the frequency bands between 4 GHz to 6 GHz according to the line 24, with most of the other frequency bands having the VSWR value equal to or smaller than 2.

The above analysis shows that the antenna module 100 of the first embodiment achieves the VSWR value equal to or smaller than 2 for wider frequency band in comparison to the antenna module 200 of the second embodiment, even when the width of the element is decreased. This is because the asymmetric shape of the antenna elements in the antenna module 100 of the first embodiment contributes to the widening of the gap between the antenna elements for decreasing the mutual influence of the antenna elements. Further, by decreasing the mutual influence between the antenna elements, the directivity of the antenna elements is substantially kept to the front direction.

In addition, as is shown by the line 23, the VSWR value for the 4 to 10 GHz frequency band is around 2 in the example with the element width defined as α λ₀/4, thereby achieving a desirable performance of the antenna module in the frequency band.

In view of the above analysis, the width of the antenna element may be preferably widened to a degree that does not allow the contact of both elements. That is, the antenna elements preferably have a wider width widened to the value substantially between α λ₀/4 to α λ₀/3 as long as the elements are detached from each other.

In addition, as shown by the line 22, the antenna module having the symmetrical shape with the element width of α λ₀/6 achieves the VSWR value of around 3 in the 4 to 10 GHz frequency band. That is, the above module may be used in the above frequency band. Therefore, widening of the frequency band is achieved when the width of the antenna element is equal to or greater than α λ₀/6.

In addition, as shown by the line 21, the antenna module having the symmetrical shape with the element width of α λ₀/60 achieves a good performance only around the 4 GHz frequency band. That is, the polarization diversity is achieved in these examples.

### Other Embodiments

Although the present invention has been fully described in connection with the preferred embodiment thereof with reference to the accompanying drawings, it is to be noted that various changes and modifications will become apparent to those skilled in the art.

For example, the spacer 28 is fixed to the substrate 1 by an inner side of the inner edge 272 in the above embodiment. However, the spacer 28 may be fixed to the reflection board 27.

In addition, the material of the reflection board 27 does not have to be copper foil. That is, the reflection board 27 may be made by using any conductive material in a board shape.

In addition, in the above embodiment, the usable frequency band is a low band of UWB. However, the antenna may be used in a high band (7 to 10.6 GHz) by replacing a value of λ₀ with a value that corresponds to 7 GHz.

In addition, in each of the above embodiments, the periphery of the ground has the arc shape on the side that faces the antenna elements. However, the periphery may not be the arc shape as long as the ground stays away from the antenna elements.

For example, the antenna element side of the ground may have a polygonal shape that connects multiple points on the arc. In other words, the periphery of the ground may have a shape that reserves a wider gap from the first (or second) antenna element as the periphery extends away from a closest point to the first (or second) feeding point toward a direction that goes away from the second (or first) antenna element, and that reserves a wider gap from the second (or first) antenna element as the periphery extends away from a closest point to the second (or first) feeding point toward a direction that goes away from the first (or second) antenna element.

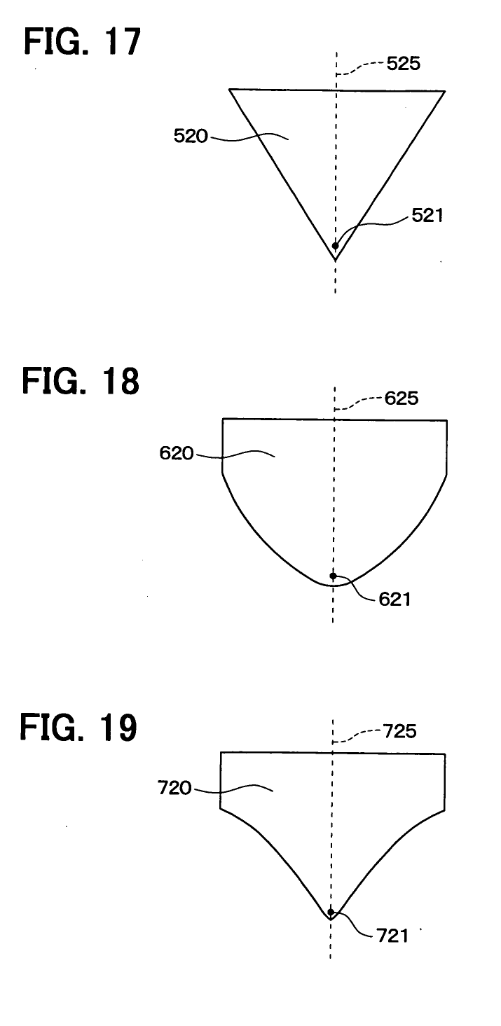

In addition, in the first to third embodiments, the antenna element has a home-base shape. However, the shape of the antenna element may take other shapes. For example, the antenna module may have a triangular antenna element 520 as shown in FIG. 17. In addition, the side of the taper portion of the antenna module may be a curved line as shown in FIGS. 18 and 19. In this case, points 521, 621, and 721 are feeding points and lines 525, 526, and 527 are lines extending from the feeding points in the polarization direction.

In addition, in the embodiments mentioned above, each of the antenna elements is disposed so that two polarization directions of the antenna elements on the substrate cross with each other perpendicularly. However, the angle between the two polarization directions of the antenna elements may not necessarily be 90 degree to realize polarization diversity. The diversity is realized as long as the angle between the polarization directions is greater than 0 degree.

In addition, the antenna module for use in a wide usable frequency band may be a module that does not realize the polarization diversity. For example, a one side polarization antenna is disclosed in a Japanese patent document JP-A-2006-345038.

Such changes and modifications are to be understood as being within the scope of the present invention as defined by the appended claims.

What is claimed is:

1. An antenna system comprising:
an antenna module for use in a wide band; and
a reflector made of a board shape conductor for causing a directivity of the antenna module, wherein
the board shape of the reflector has an outer edge and an inner edge.

2. The antenna system of claim 1, wherein
the antenna module and the reflector are connected in a manner that prohibits a direct current flowing therebetween.

3. The antenna system of claim 1, wherein
the antenna module is used in a waveband where a wavelength X defines an upper limit of the waveband, and
the reflector has, along a resonance direction of the antenna module, a dimension at least having a value of λα/2 where α defines a wavelength reduction rate of a dielectric.

4. An in-vehicle communication apparatus for use in a vehicle comprising:
the antenna system of claim 1, wherein
a compartment of the vehicle sits on an extension of a line from the reflector of the antenna system to the antenna module of the antenna system, and
the compartment of the vehicle does not sit on an extension of a line from the antenna module of the antenna system to the reflector of the antenna system.
